(19) United States
(12) Patent Application Publication
(10) Pub. No.: US 2009/0277019 A1
(43) Pub. Date: Nov. 12, 2009

(54) Child resistant safety scissor

(76) Inventor: Kerry M. Mueller, Whitehouse Station, NJ (US)

Correspondence Address: Kerry M. Mueller, 8 Orchard Drive, Whitehouse Station, NJ, 08889, US

(21) Appl. No.: 12/151,361

(22) Filed: May 6, 2008

(51) Int. Cl. B26B 13/16; B26B 13/00

(52) U.S. Cl. 30/262; 30/345

(57) ABSTRACT

A child resistant safety scissor includes a first scissor member having a handle end and a blade end and having a first pivot point located between the handle end and the blade end; a second scissor member having a handle end and a blade end and having a second pivot point located between the handle end and the blade end; a pivot rotation means located at the first pivot point of the first scissor member and at the second pivot point of the second scissor member, rotatably connecting the first scissor member to the second scissor member at the pivot points; a slideable, spring-loaded lock mechanism first component located on the handle end of the first scissor member and a spring-loaded lock mechanism second component located on the handle end of the second scissor member, the first component having a first position, being a lock position wherein it is interconnected with the second component and is inoperable, and the first component having a second position being an unlocked position, wherein it is not interconnected with the second component.

### BACKGROUND OF INVENTION

a. Field of Invention

The invention relates generally to a child resistant safety scissor that automatically locks when closed and the locking mechanism must be slid along a linear path or arc path to unlock opposing scissor members to render them operable.

b. Description of Related Art

The following patents are representative of the field pertaining to the present invention:

U.S. Pat. No. 5,925,052 to Simmons describes an umbilical surgical scissors to cut and clamp the umbilical cord following birth comprising a scissor assembly including a first and second scissor member selectively movable between a first and second position relative to each other having a clamping assembly detachably mounted thereon by a clamp assembly holder, the clamping assembly comprises a pair of clamping clips each including a first and second clamping element movable between a normally open position and a closed clamping position such that when the first and second scissor members are moved from the first position to the second position the umbilical cord is severed and the responding first and second clamping elements clamp the umbilical cord therebetween.

U.S. Pat. No. 3,651,573 to Kaplan describes a locking means for a pair of scissors which have a straight cutting blade, a pinking blade and an intermediate combined straight cutting and pinking blade. The locking means comprises openings which extend laterally through each of the aforementioned blades which openings are aligned in a given pivotal position of the blades. A locking pin is located in the opening of the combined straight cutting and pinking blade and is slightly longer than this opening. The locking pin, therefore, alternately extends into the opening in either the straight cutting blade or the pinking blade. The combined straight cutting and pinking blade is alternately locked to the straight cutting blade or the pinking blade depending upon the opening in each of these blades into which the locking pin extends. Means are provided for moving the locking pin between the aforementioned positions. The foregoing abstract is merely a resume of one general application, is not a complete discussion of all principles of operation or applications, and is not to be construed as a limitation on the scope of the claimed subject matter.

U.S. Pat. No. 2,737,718 to Hugo I. Maunu describes a pair of scissors of the character described comprising: a straight cutting blade, a pinking blade, and a combined straight cutting and pinking blade pivotally connected at one end, means for selectively locking the combined blade to either of the first two named blades for operation in unison therewith and for coaction with the other of said first two named blades, and means for actuating the blades.

Notwithstanding the prior art, the present invention is neither taught nor rendered obvious thereby.

### SUMMARY OF INVENTION

The invention solves the problems and overcomes the drawbacks and deficiencies of prior art providing a slideable spring loaded lock mechanism, as described hereinafter.

The present invention child resistant safety scissor includes: a first scissor member having a handle end and a blade end and having a first pivot point located between the handle end and the blade end; a second scissor member having a handle end and a blade end and having a second pivot point located between the handle end and the blade end; a pivot rotation means located at the first pivot point of the first scissor member and at the second pivot point of the second scissor member, rotatably connecting the first scissor member to the second scissor member at the pivot points; a slideable, spring-loaded lock mechanism first component located on the handle end of the first scissor member and a spring-loaded lock mechanism second component located on the handle end of the second scissor member, the first component having a first position, being a lock position wherein it is interconnected with the second component and is at rest, and the first component having a second position being an unlocked position, wherein it is not interconnected with the second component; a spring connected to the first scissor member and to the first component so as to bias the first component to its lock position; wherein when the child resistant safety scissor slideable, spring-loaded lock mechanism first component is in its first position, being a lock position, the first scissor member and the second scissor member are not rotatable relative to one another and the child resistant safety scissor is inoperable, and when the slideable, spring-loaded lock mechanism first component is slid away from the blade end to its second position, the first scissor member and the second scissor member are rotatable relative to one another and the child resistant safety scissor is operable.

In some preferred embodiments of the present invention child resistant safety scissor, the first scissor member blade end and the second scissor member blade end have blunt tips.

In some preferred embodiments of the present invention child resistant safety scissor, the scissor consists of a material selected from the group consisting of plastic, metal and combinations thereof.

In some preferred embodiments of the present invention child resistant safety scissor, the pivot rotation means is a screw and nut.

In some preferred embodiments of the present invention child resistant safety scissor, the first scissor member and the second scissor member includes a nut-receiving recess at the first pivot point.

In some preferred embodiments of the present invention child resistant safety scissor, the pivot rotation means is a rivet.

In some preferred embodiments of the present invention child resistant safety scissor, the pivot rotation means is an axle attached to one of the first scissor member and the second scissor member.

In some preferred embodiments of the present invention child resistant safety scissor, the first scissor member and the second scissor member include an entertainment theme thereon that is selected from the group consisting of print, paint, decal, emboss and combinations thereof.

In some preferred embodiments of the present invention child resistant safety scissor, the spring is selected from the group consisting of a bow spring, a coil spring, and resilient foam spring.

In some preferred embodiments of the present invention child resistant safety scissor, the first scissor member and the second scissor member are plastic with embedded metal blades.

The present invention a child resistant safety scissor, includes: a first scissor member having a handle end and a blade end and having a first pivot point located between the handle end and the blade end; a second scissor member having a handle end and a blade end and having a second pivot point located between the handle end and the blade end; a pivot rotation means located at the first pivot point of the first scissor member and at the second pivot point of the second scissor member, rotatably connecting the first scissor member to the second scissor member at the pivot points; a slideable, spring-loaded lock mechanism first component located on the handle end of the first scissor member, the first component being a slide button and latch, and a spring-loaded lock mechanism second component located on the handle end of the second scissor member, the second component being a latch receiver, the first component having a first position, being a lock position wherein it is interconnected with the second component and is at rest, and the first component having a second position being an unlocked position, wherein it is not interconnected with the second component; a spring connected to the first scissor member and to the first component, so as to bias the first component to its lock position; wherein when the child resistant safety scissor slideable, spring-loaded lock mechanism first component is in its first position, being a lock position, the first scissor member and the second scissor member are not rotatable relative to one another and the child resistant safety scissor is inoperable, and when the slideable, spring-loaded lock mechanism first component is slid away from the blade end to its second position, the first scissor member and the second scissor member are rotatable relative to one another and the child resistant safety scissor is operable.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a side view of an embodiment of a present invention child resistant safety scissor;

FIG. 2 shows a cut side view of the present invention child resistant safety scissor shown in FIG. 1, illustrating a blowup of the slideable spring-loaded locking mechanism;

FIG. 3 is a side view of another embodiment of a present invention child resistant safety scissor;

FIG. 4 is a side view of another embodiment of a present invention child resistant safety scissor;

FIG. 5 is a side view of still yet another embodiment of a present invention child resistant safety scissor; and,

FIG. 6 shows a partial cut side view of another preferred embodiment present invention child resistant safety scissor, illustrating the locking mechanism details.

### DETAILED DESCRIPTION OF THE EMBODIMENTS

The present invention relates to a child resistant safety scissor. It includes: a first scissor member having a handle end and a blade end and having a first pivot point located between the handle end and the blade end; a second scissor member having a handle end and a blade end and having a second pivot point located between the handle end and the blade end; a pivot rotation means located at the first pivot point of the first scissor member and at the second pivot point of the second scissor member, rotatably connecting the first scissor member to the second scissor member at the pivot points; a slideable, spring-loaded lock mechanism first component located on the handle end of the first scissor member and a spring-loaded lock mechanism second component located on the handle end of the second scissor member, the first component having a first position, being a lock position wherein it is interconnected with the second component and is at rest, and the first component having a second position being an unlocked position, wherein it is not interconnected with the second component; and a spring connected to the first scissor member and to the first component, so as to bias the first component to its lock position.

When the child resistant safety scissor slideable, spring-loaded lock mechanism first component is in its first position, being a lock position, the first scissor member and the second scissor member are not rotatable relative to one another and the child resistant safety scissor is inoperable, and when the slideable, spring-loaded lock mechanism first component is slid away from the blade end to its second position, the first scissor member and the second scissor member are rotatable relative to one another and the child resistant safety scissor is operable.

In some preferred embodiments of the present invention child resistant safety scissor, the first scissor member blade end and the second scissor member blade end have blunt tips.

The scissor consists of a material selected from the group consisting of plastic, metal and combinations thereof. In some preferred embodiments of the present invention child resistant safety scissor, the first scissor member and the second scissor member are plastic with embedded metal blades.

In some preferred embodiments of the present invention child resistant safety scissor, the pivot rotation means is a screw and nut and includes a nut-receiving recess at the first pivot point. The pivot rotation means may also be a rivet, an axle attached to one of the first scissor member and the second scissor member.

In some preferred embodiments of the present invention child resistant safety scissor, the first scissor member and the second scissor member include an entertainment theme thereon that is selected from the group consisting of print, paint, decal, emboss and combinations thereof.

The spring is selected from the group consisting of a bow spring, a coil spring and resilient foam spring.

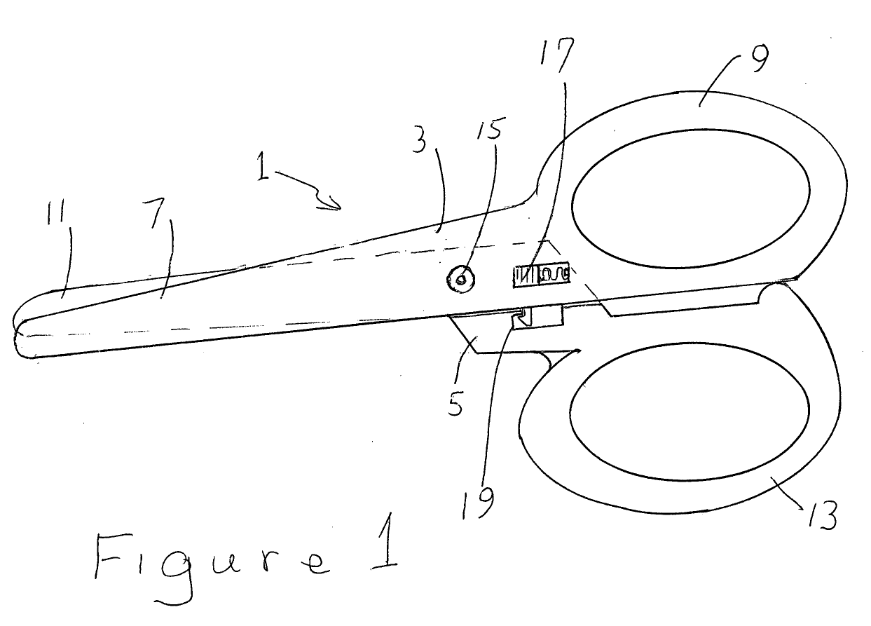

Referring now to the drawings wherein like reference numerals designate corresponding parts throughout the several views, FIG. 1 shows a side view of an embodiment of a present invention child resistant safety scissor 1.

The child resistant safety scissor 1 includes a first scissor member 3 and a second scissor member 5. First scissor member 3 has a blade end 7 and a handle end 9. Second scissor member 5 also has a blade end 11 and a handle end 13. The first scissor member 3 blade end 7 and the second scissor member 5 blade end 11 are blunt.

First scissor member 3 has a first pivot point located under rivet 15. Second scissor member 5 has a second pivot point located directly behind the first pivot point of first scissor member 3 and, thus, is also located under rivet 15. The first and second pivot points are pivot rotation means rotatably connecting the first scissor member 3 to the second scissor member 5 at the pivot points. The pivot points are located between the handle ends 9, 13 and the blade ends 7, 11.

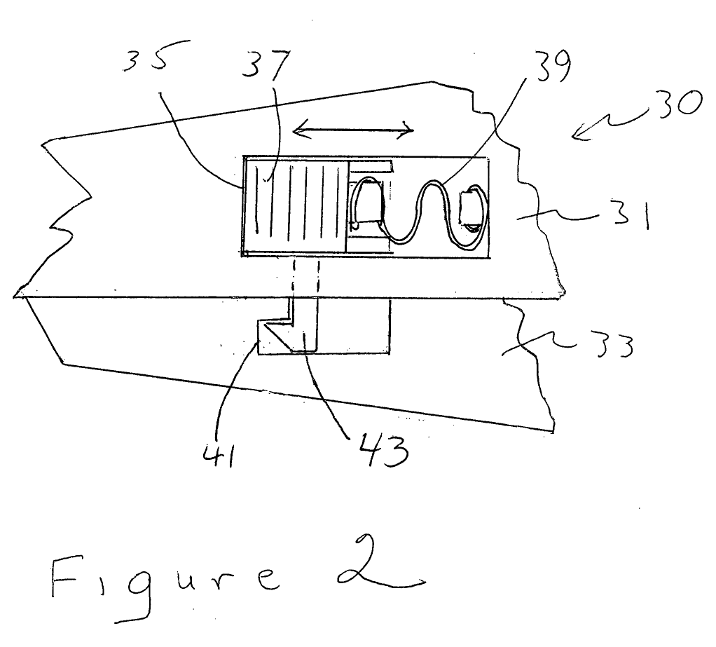

First scissor member 3 also has a slideable, spring-loaded lock mechanism first component 17, which is shown in more detail in FIG. 2. In this case, lock mechanism first component 17 is a slide button and spring. Second scissor member 5 has a lock mechanism second component 19 that is essentially a receiver for the latch described below in FIG. 2. FIG. 1 shows child resistant safety scissor 1 in its rest position which is its locked position. FIG. 1 shows the locking mechanism first component 17 hooked into locking mechanism second component 19 by the latch sliding down a ramp compressed by the spring which allows the latch to pop into the locking mechanism second component 19, much like a latch on a sliding glass door. Therefore, a user will be unable to open scissor 1 unless locking mechanism first component 17 is slid by a finger or thumb away from rivet 15, so as to unhook locking mechanism first component 17 from locking mechanism second component 19. When this is done and the scissor members are rotated to open, a user may then use it to cut. A user has a choice of either holding the locking mechanism first component 17 away from rivet 15 for multiple cuts or may immediately release locking mechanism first component 17. In either case, once locking mechanism component 17 is released it will return to its forward position toward rivet 15. As soon as the scissor is closed, it will lock up to inhibit further use.

The scissor 1 may consist of a material selected from plastic, metal and combinations thereof. The spring may be a bow spring, a coil spring or resilient foam spring.

FIG. 2 shows a cut side view of a present invention scissor 30 with a blowup of a slideable spring-loaded lock mechanism 35, which is similar to that shown in FIG. 1. The locking mechanism works similarly to that shown in FIG. 1, discussed above.

First scissor member 31 has a slideable, spring-loaded lock mechanism first component 35 which is a slide button 37, latch 43 and spring 39. Second scissor member 33 has a lock mechanism second component 41 that is essentially a receiver for the latch 43. FIG. 2 shows child resistant safety scissor 30 in its rest position which is its locked position.

When the child resistant safety scissor slideable, spring-loaded lock mechanism first component 35 is in its first position, being a lock position, the first scissor member 31 and the second scissor member 33 are not rotatable relative to one another and the child resistant safety scissor 30 is inoperable, and when the slideable, spring-loaded lock mechanism first component 35 is slid away from the blade end 7 to its second position, the first scissor member 31 and the second scissor member 33 are rotatable relative to one another and the child resistant safety scissor 30 is operable.

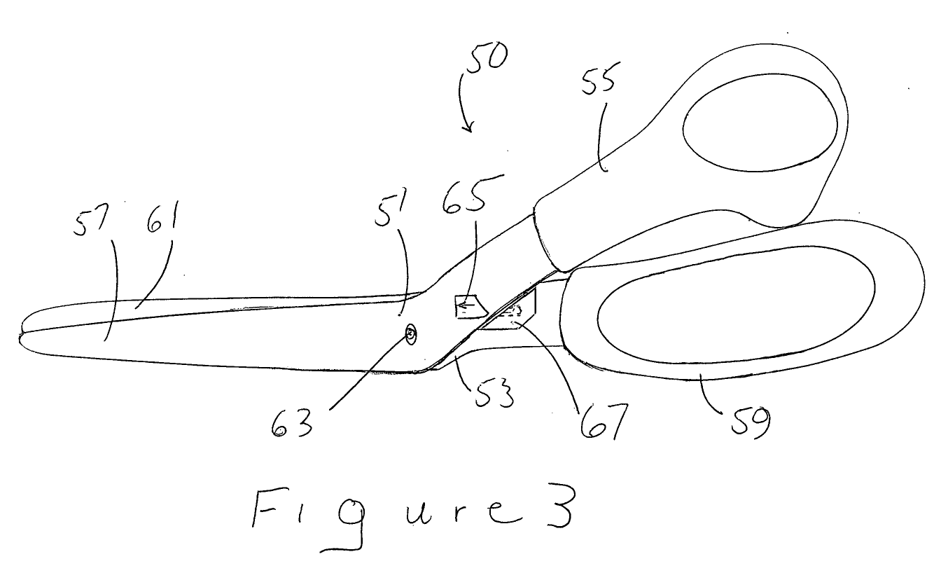

FIG. 3 shows a side view of another embodiment of a present invention child resistant safety scissor 50 in a locked position. It includes a first scissor member 51 and a second scissor member 53. First scissor member 51 has a blade end 57 and a handle end 55. Second scissor member 53 also has a blade end 61 and a handle end 59. The first scissor member 51 blade end 57 and the second scissor member 53 blade end 61 are blunt.

First scissor member 51 has a first pivot point located under nut and bolt 63. Second scissor member 53 has a second pivot point located directly behind the first pivot point of first scissor member 51 and, thus, is also located under the nut and bolt 63. The first and second pivot points are pivot rotation means rotatably connecting the first scissor member 51 to the second scissor member 53 at the pivot points. The pivot points are located between the handle ends 55, 59 and the blade ends 57 and 61. In this embodiment, one of the first scissor member 51 and the second scissor member 53 include a nut receiving recess at the first pivot point.

First scissor member 51 also has a slideable, spring-loaded lock mechanism first component 65. In this case, lock mechanism first component 65 is a slide button, latch and spring (not shown). Second scissor member 53 has a lock mechanism second component 67 that holds the latch. FIG. 3 shows child resistant safety scissor 50 in its locked position. FIG. 3 shows the locking mechanism first component 65 hooked into locking mechanism second component 67 by the latch sliding down a ramp compressed by the spring which allows the latch to pop into the locking mechanism second component 67. Therefore, a user will be able to open scissor 50 unless locking mechanism first component 65 is slid by a finger or thumb toward nut and bolt 63 so as to unhook locking mechanism first component 65 from locking mechanism second component 67. When this is done and the scissor members are rotated to open, a user may then use it to cut. A user has a choice of either holding the locking mechanism first component 65 away from nut and bolt 63 for multiple cuts or may immediately release locking mechanism first component 65. In either case, once locking mechanism component 65 is released it will return to its forward position away from nut and bolt 63. As soon as the scissor is closed, it will lock up to inhibit further use.

When the child resistant safety scissor slideable, spring-loaded lock mechanism first component is in its first position, being a lock position, the first scissor member and the second scissor member are not rotatable relative to one another and the child resistant safety scissor is inoperable, and when the slideable, spring-loaded lock mechanism first component is slid away from the blade end to its second position, the first scissor member and the second scissor member are rotatable relative to one another and the child resistant safety scissor is operable.

The scissor 50 may consist of a material selected from plastic, metal and combinations thereof. In this embodiment, the first scissor member 51 and the second scissor member 53 are plastic with embedded metal blades 57 and 63 respectively. The spring may be a bow spring, a coil spring or resilient foam spring.

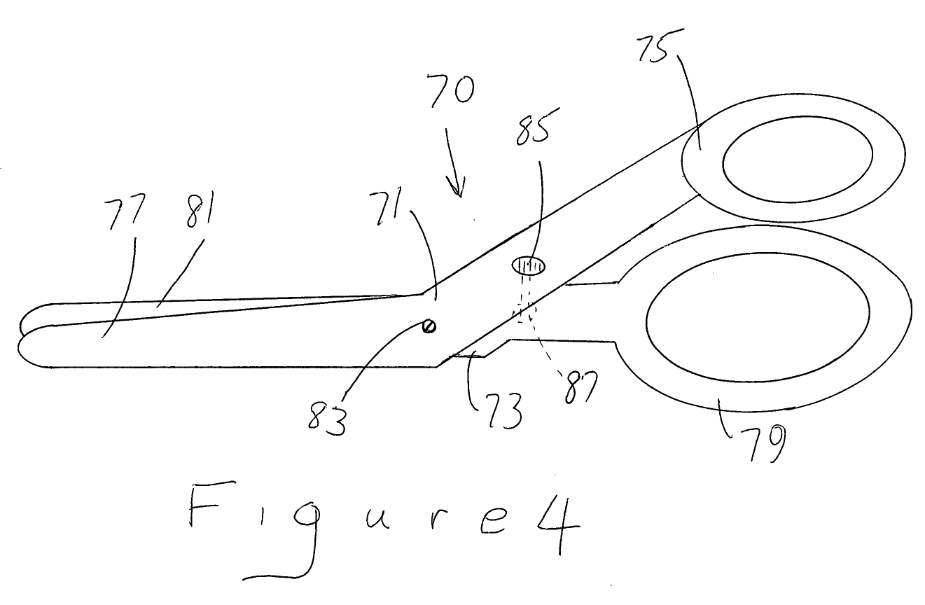

FIG. 4 shows a side view of another embodiment of a present invention child resistant safety scissor 70. It includes a first scissor member 71 and a second scissor member 73. First scissor member 71 has a blade end 77 and a handle end 75. Second scissor member 73 also has a blade end 81 and a handle end 79. The first scissor member 71 blade end 77 and the second scissor member 73 blade end 81 are blunt.

First scissor member 71 has a first pivot point located under axle 83. The axle 83 is attached to one of the first scissor member 71 and the second scissor member 73. Second scissor member 73 has a second pivot point located directly behind the first pivot point of first scissor member 71 and, thus, is also located under the axle 83. The first and second pivot points are pivot rotation means rotatably connecting the first scissor member 71 to the second scissor member 73 at the pivot points. The pivot points are located between the handle ends 75 and 79 and the blade ends 77 and 81.

First scissor member 71 also has a slideable, spring-loaded lock mechanism first component 85. In this case, lock mechanism first component 85 is a slide button, latch and spring (not shown). Second scissor member 73 has a lock mechanism second component 87 that holds the latch of the lock mechanism first component 85. FIG. 4 shows child resistant safety scissor 70 in its rest position which is locked. FIG. 4 shows the locking mechanism first component 85 hooked into locking mechanism second component 87 by the latch sliding down a ramp compressed by the spring which allows the latch to pop into the locking mechanism second component 87. Therefore, a user will be unable to open scissor 70 unless locking mechanism first component 85 is slid by a finger or thumb away from axle 87 so as to unhook locking mechanism first component 85 from locking mechanism second component 87. When this is done and the scissor members are rotated to open, a user may then use it to cut. A user has a choice of either holding the locking mechanism first component 85 away from the axle 83 for multiple cuts or may immediately release locking mechanism first component 85. In either case, once locking mechanism component 85 is released it will return to its forward position toward axle 83. As soon as the scissor 70 is closed, it will lock up to inhibit further use.

When the child resistant safety scissor slideable, spring-loaded lock mechanism first component is in its first position, being a lock position, the first scissor member and the second scissor member are not rotatable relative to one another and the child resistant safety scissor is inoperable, and when the slideable, spring-loaded lock mechanism first component is slid away from the blade end to its second position, the first scissor member and the second scissor member are rotatable relative to one another and the child resistant safety scissor is operable.

The scissor 70 may consist of a material selected from plastic, metal and combinations thereof. The spring may be a bow spring, a coil spring or resilient foam spring.

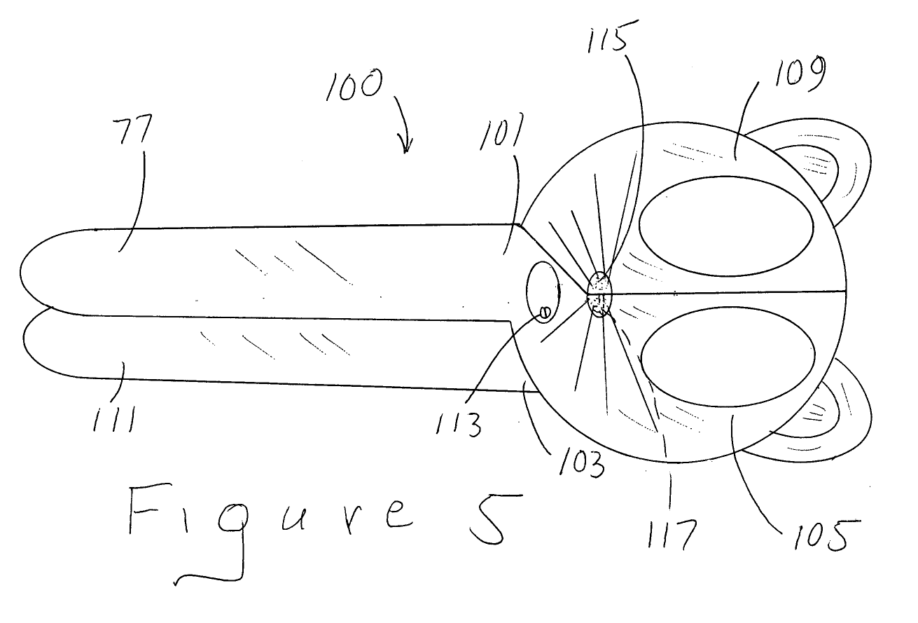

FIG. 5 shows a side view of another embodiment of a present invention child resistant safety scissor 100. It includes a first scissor member 101 and a second scissor member 103. First scissor member 101 has a blade end 107 and a handle end 105. Second scissor member 103 also has a blade end 111 and a handle end 109. The first scissor member 101 blade end 107 and the second scissor member 103 blade end 111 are blunt.

In this embodiment, the first scissor member 101 and the second scissor member 103 include an entertainment theme selected from the group consisting of print, paint, decal, emboss and combinations thereof. The entertainment theme is a cat in which the handles are shaped as a cat's face, whiskers are embossed, eyes are formed through the apertures in the handles and ears are added to the handles.

First scissor member 101 has a first pivot point located under axle 113. Second scissor member 103 has a second pivot point located directly behind the first pivot point of first scissor member 101 and, thus, is also located under the axle 113. The first and second pivot points are pivot rotation means rotatably connecting the first scissor member 101 to the second scissor member 103 at the pivot points. The pivot points are located between the handle ends 105, 109 and the blade ends 107 and 111.

First scissor member 101 also has a slideable, spring-loaded lock mechanism first component 115. In this case, lock mechanism first component 115 is a slide button, latch and spring (not shown). Second scissor member 103 has a lock mechanism second component 117 that holds the latch. FIG. 5 shows child resistant safety scissor 100 in its rest position which is its locked position. FIG. 5 shows the locking mechanism first component 115 hooked into locking mechanism second component 117 by the latch sliding down a ramp compressed by the spring which allows the latch to pop into the locking mechanism second component 117. Therefore, a user will be unable to open scissor 100 unless locking mechanism first component 115 is slid by a finger or thumb away from axle 113 so as to unhook locking mechanism first component 115 from locking mechanism second component. When this is done and the scissor members are rotated to open, a user may then use it to cut. A user has a choice of either holding the locking mechanism first component 115 away from the axle 113 and for multiple cuts or may immediately release locking mechanism first component 115. In either case, once locking mechanism component 115 is released it will return to its forward position toward axle 113. As soon as the scissor is closed, it will lock up to inhibit further use.

When the child resistant safety scissor slideable, spring-loaded lock mechanism first component is in its first position, being a lock position, the first scissor member and the second scissor member are not rotatable relative to one another and the child resistant safety scissor is inoperable, and when the slideable, spring-loaded lock mechanism first component is slid away from the blade end to its second position, the first scissor member and the second scissor member are rotatable relative to one another and the child resistant safety scissor is operable.

The scissor 100 may consist of a material selected from plastic, metal and combinations thereof. The spring may be a bow spring, a coil spring or resilient foam spring.

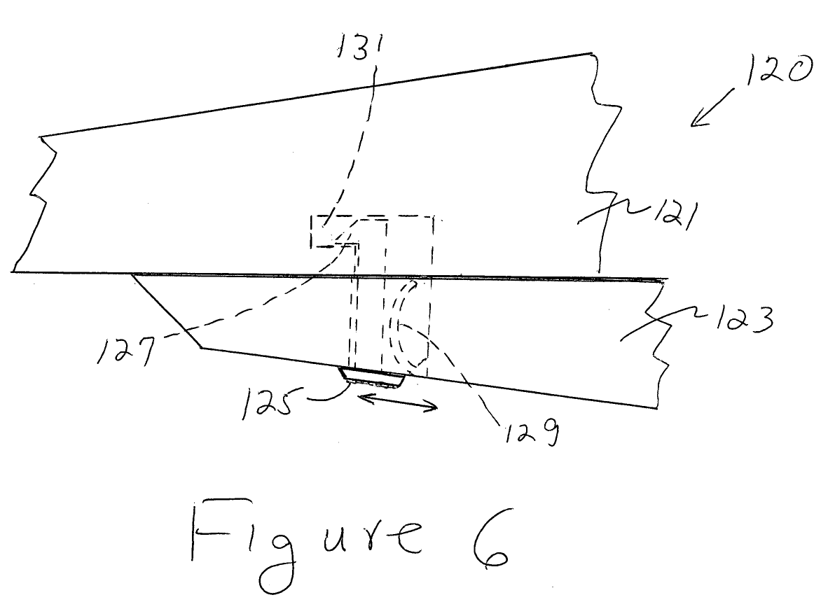

FIG. 6 shows a cut side view of another present invention scissor 120 with a slideable spring-loaded lock mechanism 125 that is located on the underside of first scissor member 123. Thus, first scissor member 123 has a slideable, spring-loaded lock mechanism first component 125 which is a slide button externally positioned to slide toward a user, but biased to its closed position (locked, as shown) via bow spring 129. Latch 127 is connected to the slide button of first component 125, as shown. Second scissor member 121 has a lock mechanism second component 131 that is essentially a receiver for the latch 127. FIG. 6 shows child resistant safety scissor 30 in its rest position which is its locked position.

When the child resistant safety scissor slideable, spring-loaded lock mechanism first component 125 is in its first position, being a lock position, the first scissor member 123 and the second scissor member 121 are not rotatable relative to one another and the child resistant safety scissor 120 is inoperable, and when the slideable, spring-loaded lock mechanism first component 35 is slid away from the blade end and toward a user to its second position, the first scissor member 123 and the second scissor member 121 are unlocked and rotatable relative to one another, and the child resistant safety scissor 120 is operable.

To summarize, the present invention thus provides a child resistant safety scissor having a locking mechanism with a spring-loaded first component located on the handle end of the first scissor member which latches with a second component located on the handle end of the second scissor member.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A child resistant safety scissor, which comprises:
a) a first scissor member having a handle end and a blade end and having a first pivot point located between said handle end and said blade end;
b) a second scissor member having a handle end and a blade end and having a second pivot point located between said handle end and said blade end;
c) a pivot rotation means located at said first pivot point of said first scissor member and at said second pivot point of said second scissor member, rotatably connecting said first scissor member to said second scissor member at said pivot points;
d) a slideable, spring-loaded lock mechanism first component located on said handle end of said first scissor member and a spring-loaded lock mechanism second component located on said handle end of said second scissor member, said first component having a first position, being a lock position wherein it is interconnected with said second component and is at rest, and said first component having a second position being an unlocked position, wherein it is not interconnected with said second component;
e) a spring connected to said first scissor member and to said first component so as to bias said first component to its lock position;
wherein when said child resistant safety scissor slideable, spring-loaded lock mechanism first component is in its first position, being a lock position, said first scissor member and said second scissor member are not rotatable relative to one another and said child resistant safety scissor is inoperable, and when said slideable, spring-loaded lock mechanism first component is slid away from said blade end to its second position, said first scissor member and said second scissor member are rotatable relative to one another and said child resistant safety scissor is operable.

2. The child resistant safety scissor of claim 1 wherein said first scissor member blade end and said second scissor member blade end have blunt tips.

3. The child resistant safety scissor of claim 1 wherein said scissor consists of a material selected from the group consisting of plastic, metal and combinations thereof.

4. The child resistant safety scissor of claim 1 wherein said pivot rotation means is a screw and nut.

5. The child resistant safety scissor of claim 4 wherein one of said first scissor member and said second scissor member includes a nut-receiving recess at said first pivot point.

6. The child resistant safety scissor of claim 1 wherein said pivot rotation means is a rivet.

7. The child resistant safety scissor of claim 1 wherein said pivot rotation means is an axle attached to one of said first scissor member and said second scissor member.

8. The child resistant safety scissor of claim 1 wherein said first scissor member and said second scissor member include an entertainment theme thereon that is selected from the group consisting of print, paint, decal, emboss and combinations thereof.

9. The child resistant safety scissor of claim 1 wherein said spring is selected from the group consisting of a bow spring, a coil spring and resilient foam spring.

10. The child resistant safety scissor of claim 1 wherein said first scissor member and said second scissor member are plastic with embedded metal blades.

11. A child resistant safety scissor, which comprises:
a) a first scissor member having a handle end and a blade end and having a first pivot point located between said handle end and said blade end;
b) a second scissor member having a handle end and a blade end and having a second pivot point located between said handle end and said blade end;
c) a pivot rotation means located at said first pivot point of said first scissor member and at said second pivot point of said second scissor member, rotatably connecting said first scissor member to said second scissor member at said pivot points;
d) a slideable, spring-loaded lock mechanism first component located on said handle end of said first scissor member, said first component being a slide button and latch, and a spring-loaded lock mechanism second component located on said handle end of said second scissor member, said second component being a latch receiver, said first component having a first position, being a lock position wherein it is interconnected with said second component and is at rest, and said first component having a second position being an unlocked position, wherein it is not interconnected with said second component;
e) a spring connected to said first scissor member and to said first component so as to bias said first component to its lock position;
wherein when said child resistant safety scissor slideable, spring-loaded lock mechanism first component is in its first position, being a lock position, said first scissor member and said second scissor member are not rotatable relative to one another and said child resistant safety scissor is inoperable, and when said slideable, spring-loaded lock mechanism first component is slid away from said blade end to its second position, said first scissor member and said second scissor member are rotatable relative to one another and said child resistant safety scissor is operable.

12. The child resistant safety scissor of claim 11 wherein said first scissor member blade end and said second scissor member blade end have blunt tips.

13. The child resistant safety scissor of claim 11 wherein said scissor consists of a material selected from the group consisting of plastic, metal and combinations thereof.

14. The child resistant safety scissor of claim 11 wherein said pivot rotation means is a screw and nut.

15. The child resistant safety scissor of claim 14 wherein one of said first scissor member and said second scissor member includes a nut-receiving recess at said first pivot point.

16. The child resistant safety scissor of claim 11 wherein said pivot rotation means is a rivet.

17. The child resistant safety scissor of claim 11 wherein said pivot rotation means is an axle attached to one of said first scissor member and said second scissor member.

18. The child resistant safety scissor of claim 11 wherein said first scissor member and said second scissor member include an entertainment theme thereon that is selected from the group consisting of print, paint, decal, emboss and combinations thereof.

19. The child resistant safety scissor of claim 11 wherein said spring is selected from the group consisting of a bow spring, a coil spring and resilient foam spring.

20. The child resistant safety scissor of claim 11 wherein said first scissor member and said second scissor member are plastic with embedded metal blades.
